(19) United States
(12) Patent Application Publication
(10) Pub. No.: US 2026/0359299 A1
(43) Pub. Date: Nov. 12, 2026

(54) AGENTIC ARTIFICIAL INTELLIGENCE ARCHITECTURE FOR CONVERSATIONAL ASSISTANT

(71) Applicant: Juniper Networks, Inc., Sunnyvale, CA (US)

(72) Inventors: Rangaswamy Jagannathan, Sunnyvale, CA (US); Navraj Pannu, Palo Alto, CA (US); Gregory Rayzman, Palo Alto, CA (US); Robert J. Friday, Los Gatos, CA (US)

(21) Appl. No.: 19/664,834

(22) Filed: Apr. 30, 2026

Related U.S. Application Data
(60) Provisional application No. 63/800,867, filed on May 6, 2025.

(51) Int. Cl. G06F 16/2455; G06F 16/242; G06F 16/28

(52) U.S. Cl. CPC G06F 16/2456; G06F 16/243; G06F 16/287

(57) ABSTRACT

Techniques are described for a conversational assistant having an agentic artificial intelligence architecture. The disclosed techniques include dynamically generating instructions to join or merge data from data domains of relational and non-relational databases for use by a generative artificial intelligence (GAI) model to accurately respond to a natural language query. A system queries a first data domain of a relational database based on the natural language query, queries a second data domain of a non-relational database based on the natural language query, dynamically generates instructions based on a first schema of the first data domain of the relational database and a second schema of the second data domain of the non-relational database to join data obtained from the first data domain and data obtained from the second data domain into a single data structure, and creates a response to the natural language query based on the joined data.

### CROSS-REFERENCE TO RELATED APPLICATIONS

This application claims the benefit of U.S. Provisional Patent Application No. 63/800,867, filed May 6, 2025, the entire contents of which is incorporated herein by reference.

### BACKGROUND

Commercial premises or sites, such as offices, hospitals, airports, stadiums, or retail outlets, often install complex wireless network systems, including a network of network access devices, e.g., wireless access points (APs) and/or switches, throughout the premises to provide network services to one or more client devices (or simply, “clients”). For example, APs are physical, electronic devices that enable other devices to wirelessly connect to a wired network using various wireless networking protocols and technologies. Many different types of client devices incorporate wireless communication technology and can be configured to connect to wireless APs when the device is in range of a compatible wireless AP in order to access a wired network. In the case of a client device running a cloud-based application, data is exchanged during an application session from the client device through one or more APs and one or more wired network devices, e.g., switches, routers, and/or gateway devices, to reach the cloud-based application server.

### BRIEF DESCRIPTION OF DRAWINGS

FIG. 1A is a block diagram of an example network system including a network management system, in accordance with one or more techniques of this disclosure.

FIG. 1B is a block diagram illustrating further example details of the network system of FIG. 1A.

FIG. 2 is a block diagram of an example access point device, in accordance with one or more techniques of this disclosure.

FIG. 3 is a block diagram of an example network management system, in accordance with one or more techniques of the disclosure.

FIG. 4 is a block diagram of an example client device, in accordance with one or more techniques of this disclosure.

FIG. 5 is a block diagram of an example network node, such as a router or switch, in accordance with one or more techniques of this disclosure.

FIG. 6 is a flowchart of an example operation of joining data from data domains of relational and non-relational databases for use by a generative artificial intelligence (GAI) model to accurately respond to a natural language query, in accordance with one or more techniques of this disclosure.

FIGS. 7A-7B are conceptual diagrams of example customer input to and responses created by a conversational assistant having an agentic AI architecture, in accordance with one or more techniques of this disclosure.

### DETAILED DESCRIPTION

In general, this disclosure describes one of more techniques of a conversational assistant having an agentic artificial intelligence architecture. The disclosed techniques include dynamically generating instructions to join or merge data from data domains of relational and non-relational databases for use by a generative artificial intelligence (GAI) model to accurately respond to a natural language query. A conversational assistant may, based on a natural language query, generate and execute queries against a database to create a response to the natural language query. In some cases, however, data relevant to the natural language query may be stored across different types of databases, including relational databases and non-relational databases. According to the disclosed techniques, a conversational assistant system comprises one or more AI agents configured to, based on a natural language query, autonomously identify relevant data domains of different databases, autonomously perform retrieval-augmented generation (RAG)-assisted generation of queries to the respective data domains of the different databases, and/or autonomously generate join instructions, e.g., high-level programming language code, to join data obtained from the different databases into a single data structure from which to create a response to the natural language query.

The techniques of this disclosure provide one or more technical advantages and practical applications. In network data systems, as an example, the number of data structures, e.g., tables, lists, trees, indices, included within a database may be too large for a GAI model to efficiently generate and execute queries against the entire database. The conversational assistant system described herein may include at least one AI agent configured to autonomously identify data domains storing data relevant to the natural language query across relational and non-relational databases based on schemas of the data domains. The conversational assistant system described herein may also include at least one AI agent configured to autonomously generate and execute one or more queries to each of the identified data domains of the relational database and the non-relational database.

Further, the data relevant to the natural language query may be stored across relational databases, e.g., Structured Query Language (SQL) databases, and non-relational databases, e.g., Not Only SQL (NoSQL) databases, such as Elasticsearch (ES) and/or Cassandra databases. In network data systems, as an example, real-time or short term data may be stored in a non-relational database while historical or long term data is stored in a relational database in order to take advantage of the features of each type of database. The conversational assistant system described herein may include at least one AI agent configured to autonomously generate join instructions based on the schemas of the identified data domains of each of the relational database and the non-relational database to normalize or align content and/or time frames of the data domains into the single data structure. The conversational assistant system described herein may further include at least one AI agent configured to autonomously generate a visualization based on the joined data held in the single data structure and output the visualization as the response to the natural language query.

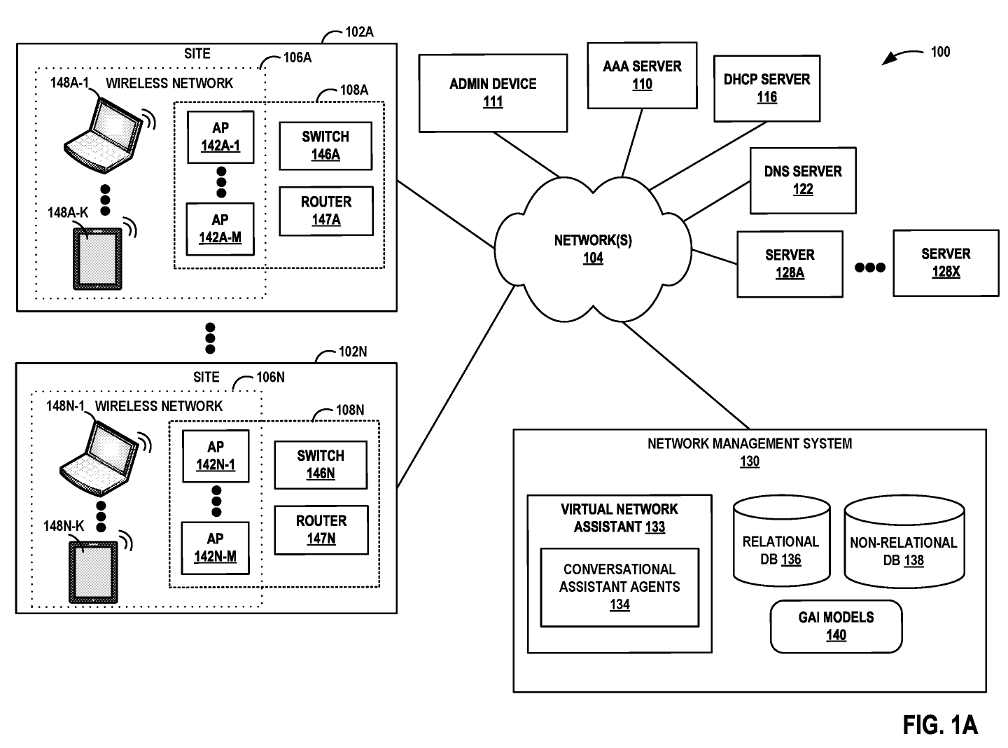

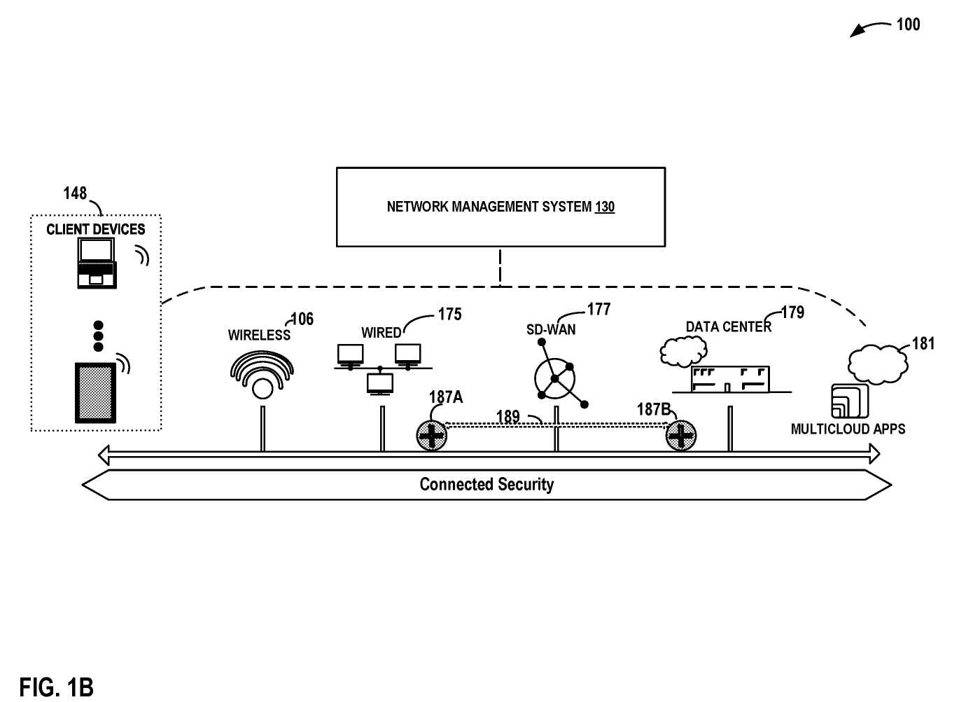

FIG. 1A is a block diagram of an example network system 100 including a network management system (NMS) 130, in accordance with one or more techniques of this disclosure. Example network system 100 includes a plurality sites 102A-102N at which a network service provider manages one or more wireless networks 106A-106N, respectively. One or more of sites 102 may be part of a larger organization having multiple logically or physically distinct locations (e.g., a branch and/or campus network). Although in FIG. 1A each site 102A-102N is shown as including a single wireless network 106A-106N, respectively, in some examples, each site 102A-102N may include multiple wireless networks, and the disclosure is not limited in this respect.

Each site 102A-102N includes a plurality of network access devices 108A-108N, such as access points (APs) 142, switches 146, and/or routers 147. For example, site 102A includes a plurality of APs 142A-1 through 142A-M. Similarly, site 102N includes a plurality of APs 142N-1 through 142N-M. Each AP 142 may be any type of wireless access point, including, but not limited to, a commercial or enterprise AP, a router, or any other device that is connected to a wired network and is capable of providing wireless network access to client devices within the site.

Each site 102A-102N also includes a plurality of client devices, otherwise known as user equipment devices (UEs), referred to generally as client devices 148, representing various wireless-enabled devices within each site. For example, a plurality of client devices 148A-1 through 148A-K are currently located at site 102A. Similarly, a plurality of client devices 148N-1 through 148N-K are currently located at site 102N. Each client device 148 may be any type of wireless client device, including, but not limited to, a mobile device such as a smart phone, tablet or laptop computer, a personal digital assistant (PDA), a wireless terminal, a smart watch, smart ring, or other wearable device. Client devices 148 may also include wired client-side devices, e.g., IoT devices such as printers, security devices, environmental sensors, or any other device connected to the wired network and configured to communicate over one or more wireless networks 106.

In order to provide wireless network services to client devices 148 and/or communicate over the wireless networks 106, APs 142 and the other wired client-side devices at sites 102 are connected, either directly or indirectly, to one or more network devices (e.g., switches, routers, or the like) via physical cables, e.g., Ethernet cables. In the example of FIG. 1A, site 102A includes a switch 146A to which each of APs 142A-1 through 142A-M at site 102A are connected, and switch 146A may, in turn, be connected to a router 147A. Similarly, site 102N includes a switch 146N to which each of APs 142N-1 through 142N-M at site 102N are connected, and switch 146N may, in turn, be connected to a router 147N. Although illustrated in FIG. 1A as if each site 102 includes a single switch 146 and a single router 147, in other examples, each site 102 may include more or fewer switches and/or routers. In addition, the APs and the other wired client-side devices of the given site may be connected to two or more switches and/or routers. Furthermore, two or more switches at a site may be connected to each other and/or connected to two or more routers, e.g., via a mesh or partial mesh topology in a hub-and-spoke architecture. In some examples, interconnected switches and routers comprise wired local area networks (LANs) at sites 102 hosting wireless networks 106.

Example network system 100 also includes various networking components for providing networking services within the wired network including, as examples, an Authentication, Authorization and Accounting (AAA) server 110 for authenticating users and/or client devices 148, a Dynamic Host Configuration Protocol (DHCP) server 116 for dynamically assigning network addresses (e.g., IP addresses) to client devices 148 upon authentication, a Domain Name System (DNS) server 122 for resolving domain names into network addresses, a plurality of servers 128A-128X (collectively “servers 128”) (e.g., web servers, databases servers, file servers and the like), and NMS 130. As shown in FIG. 1A, the various devices and systems of network system 100 are coupled together via one or more network(s) 104, e.g., the Internet and/or an enterprise intranet.

In the example of FIG. 1A, NMS 130 is a cloud-based computing platform that manages wireless networks 106A-106N at one or more of sites 102A-102N. As further described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. In some examples, NMS 130 outputs notifications, such as alerts, alarms, graphical indicators on dashboards, log messages, text / SMS messages, email messages, and the like, and/or recommendations regarding wireless network issues to a site or network administrator (“admin”) interacting with and/or operating admin device 111. Additionally, in some examples, NMS 130 operates in response to configuration input received from the administrator interacting with and/or operating admin device 111.

The administrator and admin device 111 may comprise IT personnel and an administrator computing device associated with one or more of sites 102. Admin device 111 may be implemented as any suitable device for presenting output and/or accepting user input. For instance, admin device 111 may include a display. Admin device 111 may be a computing system, such as a mobile or non-mobile computing device operated by a user and/or by the administrator. Admin device 111 may, for example, represent a workstation, a laptop or notebook computer, a desktop computer, a tablet computer, or any other computing device that may be operated by a user and/or present a user interface in accordance with one or more aspects of the present disclosure. Admin device 111 may be physically separate from and/or in a different location than NMS 130 such that admin device 111 may communicate with NMS 130 via network 104 or other means of communication.

In some examples, one or more of the network access devices, e.g., APs 142, switches 146, and/or routers 147, may connect to edge devices (not shown in FIG. 1A) acting as tunnel terminators associated with NMS 130. The edge devices may comprise cloud-managed, wireless LAN controllers. Each edge device may comprise an on-premises device at one or more of sites 102 or within a datacenter of the organization that is in communication with NMS 130 to extend certain microservices from NMS 130 to the on-premises network access devices 108 while using NMS 130 and its distributed software architecture for scalable and resilient operations, management, troubleshooting, and analytics.

Each one of the network devices of network system 100, e.g., servers 110, 116, 122 and/or 128, APs 142, client devices 148, switches 146, routers 147, and any other servers or devices attached to or forming part of network system 100, may include a system log or an error log wherein each one of these network devices records the status of the network device including normal operational status and error conditions. Throughout this disclosure, one or more of the network devices of network system 100, e.g., servers 110, 116, 122 and/or 128, APs 142, client devices 148, switches 146, and routers 147, may be considered “third-party” network devices when owned by and/or associated with a different entity than NMS 130 such that NMS 130 does not receive, collect, or otherwise have access to the recorded status and other data of the third-party network devices. In some examples, edge devices (not shown in FIG. 1A) on-premises at site 102 may provide a proxy through which the recorded status and other data of the third-party network devices may be reported to NMS 130.

In some examples, NMS 130 monitors network data, e.g., client level statistics, radio statistics, transmission statistics, event data, and/or one or more service level expectation (SLE) metrics, received from wireless networks 106A-106N at each site 102A-102N, respectively. NMS 130 stores the network data in at least one of relational database (“relational DB”) 136 or non-relational database (“non-relational DB”) 138. Relational database 136 may comprise a Structured Query Language (SQL) database configured to store data in structured tables having a predefined, fixed schema. Relational database 136, alternatively referred to herein as SQL database 136, may be well suited for storage of historical, long term network data such as network data obtained for time periods more than one week or 7-days ago. In some examples, relational database 136 may store network data that is at least 1-day or 24-hours old to allow enough time to process the obtained network data into the structured format of the tables of relational database 136.

Non-relational database 136 may comprise a Not Only SQL (NoSQL) database, such as Elasticsearch (ES) and/or Cassandra, configured to store data in flexible or semi-structured indices, lists, or trees having dynamic schemas. In some examples, non-relational database 138 may be configured to store a mix of structured and unstructured data. Non-relational database 138, alternatively referred to herein as ES database 138, may be well suited for storage of real-time and/or short term network data such as network data obtained for time periods in the most recent week or 7-days or at least the most recent 1-day or 24-hours.

Based at least in part on the network data, NMS 130 manages network resources, such as APs 142 at each site, to deliver a high-quality wireless experience to end users, IoT devices and clients at the site. For example, NMS 130 may include a virtual network assistant (VNA) 133 that implements an event processing platform for providing real-time insights and simplified troubleshooting for IT operations, and that automatically takes corrective action or provides recommendations to proactively address wireless network issues. VNA 133 may, for example, include an event processing platform configured to process hundreds or thousands of concurrent streams of network data from sensors and/or agents associated with APs 142 and/or nodes within network 104. For example, VNA 133 of NMS 130 may include an underlying analytics and network error identification engine and alerting system in accordance with various examples described herein. The underlying analytics engine of VNA 133 may apply historical data and models to the inbound event streams to compute inferences and assertions, such as identified anomalies or predicted occurrences of events constituting network issues. Further, VNA 133 may provide real-time alerting and reporting to notify a site or network administrator via admin device 111 of any predicted events, anomalies, trends, and may perform root cause analysis and automated or assisted issue remediation. In some examples, VNA 133 of NMS 130 may apply machine learning techniques to identify the root cause of error conditions detected or predicted from the streams of network data. If the root cause may be automatically resolved, VNA 133 may invoke one or more corrective actions to correct the root cause of the issue, thus automatically improving the underlying SLE metrics and also automatically improving the user experience.

In the example of FIG. 1A, VNA 133 includes one or more conversational assistant agents 134. Conversational assistant agents 134 may be part of an overall conversational assistant system that receives a natural language query about a state of a network (e.g., one of wireless networks 106 or wired networks of sites 102, a wide-area network connecting two or more of sites 102, and/or enterprise network 104) or a network device (e.g., one or more of APs 142, switches 14, routers 147, or other network nodes) from a user device, such as admin devices 111. The conversational assistant system may be configured to process user inputs, such as text strings of natural language queries, and generate responses. In some examples, the conversational assistant system may include and/or use one or more natural language processors configured to process the user inputs. The conversational assistant system may be configured to conduct a chat conversation that simulates a way a human would behave as a conversation partner, which may help to simplify and/or improve a satisfaction of an administrator monitoring a network, e.g., via admin device 111.

A conversational assistant may, based on a natural language query, generate and execute queries against a database to create a response to the natural language query. In some cases, however, the natural language query may be a complex, multi-step query that may use information drawn from multiple different data structures of multiple different databases, e.g., relational database 136 and non-relational database 138, to generate an accurate response. Solutions for using data stored in both relational and non-relational databases may perform a series of queries in each of the different types of databases, but the results of the individual queries may fail to normalize, align, or otherwise correlate the data across the database types.

Conversational assistant agents 134 may include one or more artificial intelligence (AI) agents configured to use AI, such as one or more of generative artificial intelligence (GAI) models 140. Conversational assistant agents 134 may, based on a natural language query, autonomously identify relevant data domains, generate queries, and execute queries for each of relational database 136 and non-relational database 138. In accordance with one or more techniques of this disclosure, at least one AI agent of conversational assistant agents 134 is configured to dynamically generate instructions to join or merge data from data domains of relational database 136 and non-relational database 138 for use by one of GAI models 140 to accurately respond to the natural language query. One or more of GAI models 140 may comprise a large language model (LLM) that, in some cases, may be guided or assisted by a retrieval-augmented generation (RAG) tool.

The techniques of this disclosure provide one or more technical advantages and practical applications. In the example of network system 100, the number of data structures, e.g., tables, lists, trees, indices, included within a database, e.g., relational database 136, may be too large for one of GAI models 140 to efficiently generate and execute queries against the entire database. Conversational assistant agent 134 may include at least one AI agent configured to autonomously identify data domains storing data relevant to the natural language query across relational database 136 and non-relational database 138 based on schemas of the data domains. Conversational assistant agents 134 may also include at least one AI agent configured to autonomously generate and execute one or more queries to each of the identified data domains of relational database 136 and non-relational database 138.

Further, the data relevant to the natural language query may be stored across relational database 136 and non-relational database 138. In the example of network system 100, real-time or short term data may be stored in non-relational database 138 while historical or long term data is stored in relational database 136. Conversational assistant agents 134 may include at least one AI agent configured to autonomously generate join instructions based on the schemas of the identified data domains of each of relational database 136 and non-relational database 138 to normalize or align content and/or time frames of the data domains into the single data structure. Conversational assistant agents 134 may further include at least one AI agent configured to autonomously generate a visualization based on the joined data held in the single data structure and output the visualization as the response to the natural language query for display via a user interface, e.g., to a network administration using admin device 111.

In operation, NMS 130 observes, collects, and/or receives network data, which may take the form of data extracted from messages, counters, and statistics, for example. In accordance with one specific implementation, a computing device is part of NMS 130. In accordance with other implementations, NMS 130 may comprise one or more computing devices, dedicated servers, virtual machines, containers, services, or other forms of environments for performing the techniques described herein. Similarly, computational resources and components implementing VNA 133 may be part of the NMS 130, may execute on other servers or execution environments, or may be distributed to nodes within network 104 (e.g., switches, controllers, routers, gateways, and the like).

For example, one or more computing device(s) configured to execute the functionality of the techniques of this disclosure may reside in a dedicated server or be included in any other server in addition to or other than NMS 130, or may be distributed throughout network 100, and may or may not form a part of NMS 130.

FIG. 1B is a block diagram illustrating further example details of the network system of FIG. 1A. In this example, FIG. 1B illustrates NMS 130 configured to operate according to an artificial intelligence / machine-learning-based computing platform providing comprehensive automation, insight, and assurance (WiFi Assurance, Wired Assurance and WAN assurance) spanning from “client,” e.g., user devices 148 connected to wireless network 106 and wired LAN 175 (far left of FIG. 1B), to “cloud,” e.g., cloud-based application services 181 that may be hosted by computing resources within data centers 179 (far right of FIG. 1B).

As described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. For example, NMS 130 may be configured to proactively monitor and adaptively configure network 100 so as to provide self-driving capabilities. Moreover, NMS 130 includes a natural language processing engine to provide AI-driven support and troubleshooting, anomaly detection, AI-driven location services, and AI-driven radio frequency (RF) optimization with reinforcement learning.

As illustrated in the example of FIG. 1B, AI-driven NMS 130 also provides configuration management, monitoring and automated oversight of software defined wide-area network (SD-WAN) 177, which operates as an intermediate network communicatively coupling wireless networks 106 and wired LANs 175 to data centers 179 and application services 181. In general, SD-WAN 177 provides seamless, secure, traffic-engineered connectivity between “spoke” routers 187A of wired networks 175 hosting wireless networks 106, such as branch or campus networks, to “hub” routers 187B further up the cloud stack toward cloud-based application services 181. SD-WAN 177 often operates and manages an overlay network on an underlying physical WAN, which provides connectivity to geographically separate customer networks. In other words, SD-WAN 177 extends Software-Defined Networking (SDN) capabilities to a WAN and allows networks to decouple underlying physical network infrastructure from virtualized network infrastructure and applications such that the networks may be configured and managed in a flexible and scalable manner.

In some examples, underlying routers of SD-WAN 177 may implement a stateful, session-based routing scheme in which the routers 187A, 187B dynamically modify contents of original packet headers sourced by client devices 148 to steer traffic along selected paths, e.g., path 189, toward application services 181 without requiring use of tunnels and/or additional labels. In this way, routers 187A, 187B may be more efficient and scalable for large networks since the use of tunnel-less, session-based routing may enable routers 187A, 187B to achieve considerable network resources by obviating the need to perform encapsulation and decapsulation at tunnel endpoints. Moreover, in some examples, each router 187A, 187B may independently perform path selection and traffic engineering to control packet flows associated with each session without requiring use of a centralized SDN controller for path selection and label distribution. In some examples, routers 187A, 187B implement session-based routing as Secure Vector Routing (SVR).

In some examples, AI-driven NMS 130 may enable intent-based configuration and management of network system 100, including enabling construction, presentation, and execution of intent-driven workflows for configuring and managing devices associated with wireless networks 106, wired LAN networks 175, and /or SD-WAN 177. For example, declarative requirements express a desired configuration of network components without specifying an exact native device configuration and control flow. By utilizing declarative requirements, what should be accomplished may be specified rather than how it should be accomplished. Declarative requirements may be contrasted with imperative instructions that describe the exact device configuration syntax and control flow to achieve the configuration. By utilizing declarative requirements rather than imperative instructions, a user and/or user system is relieved of the burden of determining the exact device configurations to achieve a desired result of the user/system such that management and configuration of the network devices becomes more efficient.

In some examples, one or more of NMS 130, or particular portions thereof, may be implemented as a service (“-aaS”). For example, NMS 130 may be executed as virtual applications hosted by one or more servers of a cloud service provider network, e.g., servers 128 of FIG. 1A and/or application services 181 of FIG. 1B, and licensed, by a cloud service provider, to an operator of, e.g., sites 102 on an on-going, subscription basis.

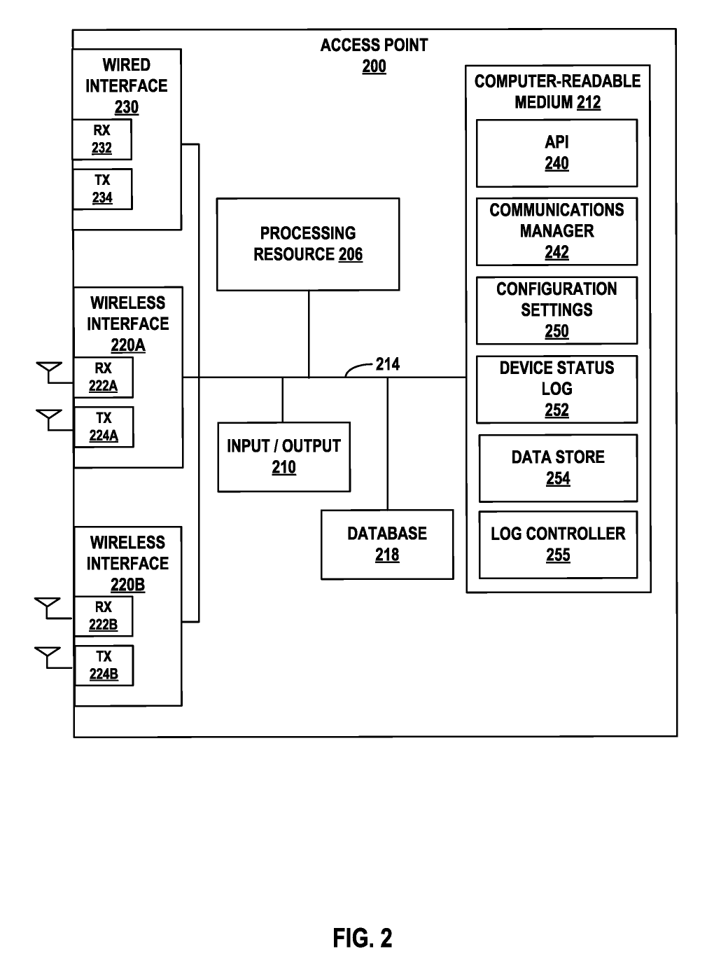

FIG. 2 is a block diagram of an example access point (AP) device 200, in accordance with one or more techniques of this disclosure. Example access point 200 shown in FIG. 2 may be used to implement any of APs 142 as shown and described herein with respect to FIG. 1A. Access point 200 may comprise, for example, a Wi-Fi, Bluetooth and/or Bluetooth Low Energy (BLE) base station or any other type of wireless access point.

In the example of FIG. 2, access point 200 includes a wired interface 230, wireless interfaces 220A-220B, processing resource 206, computer-readable medium 212, input/output 210, and database 218 coupled together via a bus 214 over which the various elements may exchange data and information. Wired interface 230 represents a physical network interface and includes a receiver 232 and a transmitter 234 for sending and receiving network communications, e.g., packets. Wired interface 230 couples, either directly or indirectly, access point 200 to a wired network device, such as a switch, within the wired network via a cable, such as an Ethernet cable.

First and second wireless interfaces 220A and 220B, alternatively referred to as “radios,” represent wireless network interfaces and include receivers 222A and 222B, respectively, each including a receive antenna via which access point 200 may receive wireless signals from wireless communications devices, such as client devices. First and second wireless interfaces 220A and 220B further include transmitters 224A and 224B, respectively, each including transmit antennas via which access point 200 may transmit wireless signals to wireless communications devices, such as client devices. In some examples, first wireless interface 220A may include a Wi-Fi 802.11 interface (e.g., 2.4 GHz, 5 GHz and/or 6 GHz) and second wireless interface 220B may include a Bluetooth interface and/or a Bluetooth Low Energy (BLE) interface. In other examples, access point 200 may include two or more Wi-Fi 802.11 interfaces, each operating on a different wireless frequency band. In additional examples, access point 200 may include an ultra-wideband (UWB) chipset (not shown) having a transmitter and/or antennas used for short-range wireless communication in accordance with UWB communication protocols.

Processing resource 206 includes one or more programmable hardware-based processors configured to execute software instructions, such as those used to define a software or computer program, stored to a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause processing resource 206 to perform the techniques described herein.

Computer-readable medium 212 includes one or more devices configured to store programming units and/or data associated with operation of access point 200. For example, computer-readable medium 212 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processing resource 206 to perform the techniques described herein. Database 218 includes one or more data storage structures configured to store data for use by access point 200, e.g., data received from a network management system for cloud-based management of access point 200.

In this example, computer-readable medium 212 stores executable software including an application programming interface (API) 240, a communications manager 242, configuration settings 250, a device status log 252, a data store 254, and a log controller 255. Device status log 252 includes a list of events specific to access point 200. The events may include a log of both normal events and error events such as, for example, memory status, reboot or restart events, crash events, cloud disconnect with self-recovery events, low link speed or link speed flapping events, Ethernet port status, Ethernet interface packet errors, upgrade failure events, firmware upgrade events, configuration changes, etc., as well as a time and date stamp for each event. Log controller 255 determines a logging level for access point 200 based on instructions from a network management system. Data store 254 may store any data used and/or generated by access point 200, including data collected from client devices, such as data used to calculate one or more SLE metrics, e.g., client-level statistics, radio statistics, and/or transmission statistics, that is transmitted by access point 200 for cloud-based management of wireless networks by a network management system.

Input/output (I/O) 210 represents physical hardware components that enable interaction with a user, such as buttons, a display, and the like. Although not shown, computer-readable medium 212 typically stores executable software for controlling a user interface with respect to input received via I/O 210. Communications manager 242 includes program code that, when executed by processing resource 206, allow access point 200 to communicate with client devices 148 and/or network 104 via any of interface(s) 230 and/or 220A-220B. Configuration settings 250 include any device settings for access point 200 such as radio settings for each of wireless interface(s) 220A-220B. These settings may be configured manually or may be remotely monitored and managed by a network management system to optimize wireless network performance on a periodic (e.g., hourly or daily) basis.

As described herein, access point 200 may measure and report network data from device status log 252 and/or data store 254 to a network management system. The network data may comprise event data, statistical data, and/or other SLE-related data. The network data may include various parameters indicative of the performance and/or status of the wireless network. The parameters may be measured and/or determined by one or more of the client devices and/or by one or more of the APs in a wireless network. Access point 200 may periodically create a package of the statistical data according to a periodic interval, e.g., every 1-3 minutes, and send the package to the network management system. Access point 200 may also monitor client state changes and other events and send asynchronous event data to the network management system.

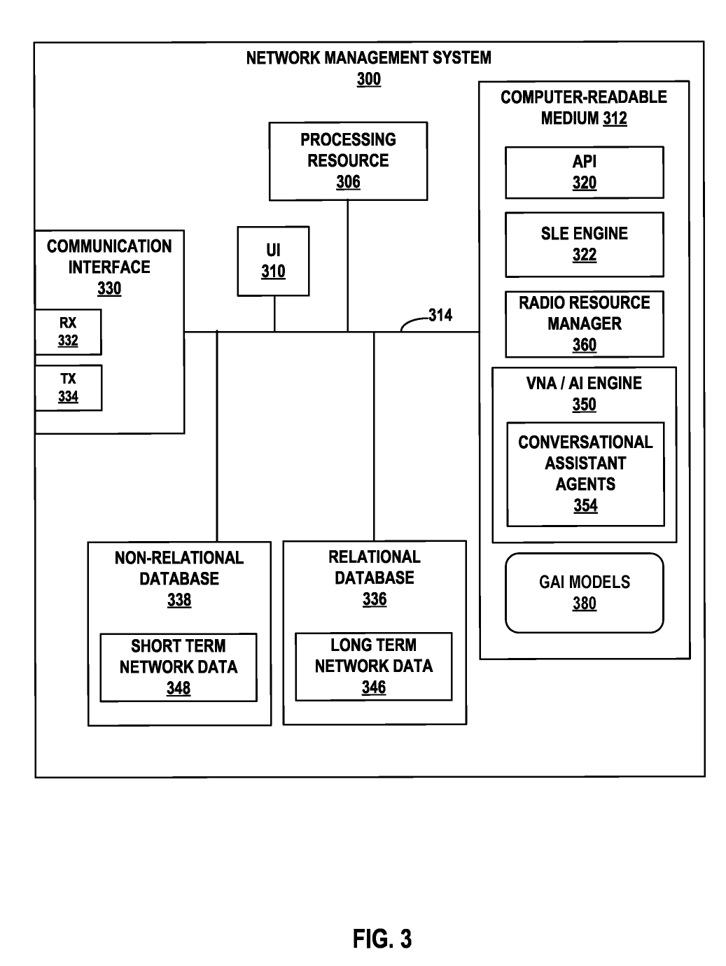

FIG. 3 is a block diagram of an example network management system (NMS) 300, in accordance with one or more techniques of the disclosure. NMS 300 may be used to implement, for example, NMS 130 in FIGS. 1A-1B. In such examples, NMS 300 is responsible for monitoring and management of one or more wireless networks at one or more sites.

NMS 300 includes a communications interface 330, processing resource 306, a user interface (UI) 310, a computer-readable medium 312, a relational database 336, and a non-relational database 338. The various elements are coupled together via a bus 314 over which the various elements may exchange data and information. In some examples, NMS 300 receives data from one or more of client devices, network access devices (such as APs, switches, and/or routers), and other network nodes, e.g., gateway routers, which may be used to calculate one or more SLE metrics and/or update network data stored in relational database 336 and/or non-relational database 338. NMS 300 analyzes this data for cloud-based management of wireless networks.

Processing resource 306 executes software instructions, such as those used to define a software or computer program, stored to a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause processing resource 306 to perform the techniques described herein. In some examples, processing resource 306 may include one or more processors that are capable of running GAI models 380 with or without additional hardware accelerators or other assistance. The one or more processors may comprise one or more of a central processing unit (CPU), a graphics processing unit (GPU), a neural processing unit (NPU), a tensor processing unit (TPU), an artificial intelligence unit (AIU), or another type of specialized processor designed to efficiently run AI models.

Communications interface 330 may include, for example, an Ethernet interface. Communications interface 330 couples NMS 300 to an enterprise network and/or the Internet and/or any local area networks. Communications interface 330 includes a receiver 332 and a transmitter 334 by which NMS 300 receives/transmits data and information to/from any of client devices, network access devices (such as APs, switches, and/or routers), servers, and/or any other network nodes, devices, or systems forming part of a network system. In some scenarios described herein in which the network system includes “third-party” network devices that are owned and/or associated with different entities than NMS 300, NMS 300 does not receive, collect, or otherwise have access to network data from the third-party network devices.

The data and information received by NMS 300 may include, for example, telemetry data, SLE-related data, or event data received from one or more of client devices, network access devices (such as AP, switches, and/or routers), or other network nodes, e.g., gateway routers, used by NMS 300 to remotely monitor the performance of wireless networks and application sessions from client device to cloud-based application server. NMS 300 may further transmit data via communications interface 330 to any of client devices, network access devices (such as APs, switches, and/or routers), other network nodes remotely manage wireless networks and portions of the wired network.

Computer-readable medium 312 includes one or more devices configured to store programming units and/or data associated with operation of NMS 300. For example, computer-readable medium 312 may include a computer-readable storage medium, such as a non-transitory computer-readable medium including a storage device (e.g., a disk drive, or an optical drive) or a memory (such as Flash memory or RAM) or any other type of volatile or non-volatile memory, that stores instructions to cause processing resource 306 to perform the techniques described herein.

Relational database 336 includes one or more data storage structures, e.g., tables, configured to store long term network data 346 for use by NMS 300 for cloud-based management of wireless networks, the wired network, and/or the WAN. Relational database 336 may comprise a SQL database and long term network data 346 may include network data obtained for time periods more than one week or 7-days in the past, or at least 1-day or 24-hours in the past. Non-relational database 338 includes one or more data storage structures, e.g., lists, trees, indices, configured to store short term network data 348 for use by NMS 300 for cloud-based management of wireless networks and portions of the wired network and the WAN. Non-relational databased 338 may comprise a NoSQL database, such as ES and/or Cassandra, and short term network data 348 may include network data obtained for time periods in the most recent week or 7-days or at least the most recent 1-day or 24-hours. In some scenarios, short term network data 348 may include real-time data.

In the illustrated example, computer-readable medium 312 includes an API 320, an SLE engine 322, a virtual network assistant (VNA)/AI engine 350, and a radio resource management (RRM) engine 360. In accordance with the disclosed techniques, VNA/AI engine 350 includes conversational assistant agents 354, which may operate substantially similar to conversation assistant agents 134 of FIG. 1A. NMS 300 may also include any other programmed units, software engines and/or interfaces configured for remote monitoring and management of wireless networks, the wired network and/or the WAN, including remote monitoring and management of any of APs, switches, routers, or other network devices, e.g., gateway routers.

SLE engine 322 enables set up and tracking of thresholds for SLE metrics for each wireless network. SLE engine 322 further analyzes SLE-related data collected by APs from client devices in each wireless network. This data is transmitted to NMS 300, which executes SLE engine 322 to determine one or more SLE metrics for each client device currently connected to each wireless network. This data, in addition to any network data collected by one or more APs in the wireless network, is transmitted to NMS 300 and stored as, for example, short term network data 348 in non-relational database 338 and/or long term network data 346 in relational database 338.

RRM engine 360 monitors one or more metrics for each site in order to learn and optimize the radio frequency (RF) environment at each site. For example, RRM engine 360 may monitor the coverage and capacity SLE metrics for a wireless network at a site in order to identify potential issues with SLE coverage and/or capacity in the wireless network and to make adjustments to the radio settings of the access points at each site to address the identified issues. For example, RRM engine may determine channel and transmit power distribution across all APs in each wireless network. For example, RRM engine 360 may monitor events, power, channel, bandwidth, and number of clients connected to each AP. RRM engine 360 may further automatically change or update configurations of one or more APs at a site with an aim of improving the coverage and capacity SLE metrics and thus to provide an improved wireless experience for the user.

VNA/AI engine 350 analyzes data received from network devices as well as its own data to identify when undesired or abnormal states are encountered at one of the network devices. For example, VNA/AI engine 350 may identify the root cause of any undesired or abnormal states, e.g., any poor SLE metric(s) indicative of connection issues at one or more network devices. In addition, VNA/AI engine 350 may automatically invoke one or more corrective actions intended to address the identified root cause(s) of one or more poor SLE metrics. Examples of corrective actions that may be automatically invoked by VNA/AI engine 350 may include, but are not limited to, invoking RRM 360 to reboot one or more APs, adjusting/modifying the transmit power of a specific radio in a specific AP, adding SSID configuration to a specific AP, reassigning channels to radios of an AP or a set of APs, etc. The corrective actions may further include restarting a switch and/or a router, invoking download of new software to an AP, switch, or router, etc. These corrective actions are given for example purposes only, and the disclosure is not limited in this respect. If automatic corrective actions are not available or do not adequately resolve the root cause, VNA/AI engine 350 may proactively provide a notification including recommended corrective actions to be taken by IT personnel, e.g., a site or network administrator using an admin device, to address the network error.

Conversational assistant agents 354 may be configured to process user inputs, such as natural language text strings or selections of user interface elements, received via UI 310 and generate responses. In some examples, conversational assistant agents 354 may include and/or use one or more natural language processors configured to process the user inputs. Conversational assistant agents 354 may be configured to generate a conversational assistant for display, e.g., on an admin device, for conducting a chat conversation that simulates a way a human would behave as a conversation partner, which may help to simplify and/or improve a satisfaction of a network administrator for an enterprise network of a customer organization.

A conversational assistant system may use RAG tools to assist LLMs in generating response to user queries. For example, a RAG tool may pull schemas for all tables in a SQL database and generate queries for execution against all tables. In network systems, however, the number of tables included in relational data 336 may be too large, e.g., hundreds of tables per SQL database, for a conversational assistant system to efficiently pull schemas and query all tables. Moreover, even based on a limited number of tables, e.g., five to fifteen tables, in some scenarios the data to accurately respond to a user query may be stored across different types of databases, e.g., relational database 336 and non-relational database 338. For example, NMS 300 may store real-time or short term network data 348 in non-relational database 338 while historical or long term network data 346 is stored in relational database 336. Solutions for using data stored in both relational and non-relational databases may perform a series of queries in each of the different types of databases, but the results of the individual queries may fail to normalize, align, or otherwise correlate the data across the database types.

Conversational assistant agents 354 of VNA/AI engine 350 may include one or more AI agents configured to use one or more of GAI models 380 to, based on a natural language query, autonomously identify relevant data domains, generate queries, execute queries for each of relational database 336 and non-relational database 338. In accordance with one or more techniques of this disclosure, at least one AI agent of conversational assistant agents 354 is configured to dynamically generate instructions to join or merge data from data domains of relational database 336 and non-relational database 338 for use by one of GAI models 380 to accurately respond to the natural language query. One or more of GAI models 380 may comprise an LLM that, in some cases, may be guided or assisted by a RAG tool.

The disclosed techniques include multiple steps or stages in which one or more AI agents of conversational assistant agents 354 use one or more of GAI models 380 to autonomously create a response to a natural language query received via UI 310.

As one step or stage, conversational assistant agents 354 may include one or more AI agents configured to autonomously identify data domains storing data relevant to the natural language query across relational database 336 and non-relational database 338 based on schemas of the data domains. An AI agent may determine whether the natural language query is associated with data stored in one or both of relational database 336 and non-relational database 338. If the natural language query is associated with data stored in both databases 336, 338, e.g., long term network data 346 and short term network data 348, at least one other AI agent may autonomously identify a relevant data domain of each of the databases 336, 338.

For example, at least one AI agent of conversational assistant agents 354 may classify the natural language query into one or more topics of a plurality of topics. In some examples, the plurality of topics may comprise eight to twelve different topics, such as access points, switches, gateways, wireless assurance, wired assurance, WAN assurance, pre-connection, post-connection, radio or RF spectrum, failure events, or the like. Each topic may be assigned one or more data structures and corresponding schemas of relational database 336, one or more data structures and corresponding schemas of non-relational database 338, and one or more example queries and corresponding responses. For example, a particular topic may be assigned between five and fifteen data structures, e.g., tables, within relational database 336 and the corresponding schemas or definitions of the content of the tables. The same particular topic may also be assigned one or two data structures, e.g., lists, trees, or indices, within non-relational database 338 and the corresponding schemas or definitions of the content of the data structures. The same particular topic may further be assigned one or more topic-specific context examples that may include network terminology, queries or prompts, and corresponding responses.

At least one AI agent of conversational assistant agents 354 may determine a first data domain of relational database 336 as including data relevant to the one or more topics of the natural language query. A first schema of the first data domain may define a structure, content, and/or time frame of the data stored in the one or more data structures within relational database 336 assigned to the one or more topics of the natural language query. Similarly, at least another AI agent of conversational assistant agents 354 may determine a second data domain of non-relational database 338 as storing data relevant to the one or more topics of the natural language query. A second schema of the second data domain may define a structure, content, and/or time frame of the data stored in the one or more data structures within non-relational database 386 assigned to the one or more topics of the natural language query.

In another example, at least one AI agent of conversational assistant agents 354 may provide, to one of GAI models 380, the natural language query to obtain a selection of the first data domain comprising one or more data structures of a plurality of data structures within relational database 336. At least another AI agent of conversational assistant agents 354 may provide, to another one of GAI models 380, the natural language query to obtain a selection of the second data domain comprising one or more data structures of a plurality of data structures within non-relational database 338.

The above described step or stage of classifying the natural language query may provide a process improvement in terms of accuracy and speed by identifying a limited number of data structures (e.g., 5 to 15 tables of relational database 336 and 1 to 2 indices of non-relational database 338) for which to generate and execute queries. In some examples, AI agents of conversational assistant agents 354 may use schemas of the data structures that describe what data the data structures hold to identify the relevant data structures for the natural language query. The AI agents 354 and/or GAI models 380 may learn to construct smart prompts as schemas may not be descriptive or may use different terms between data structures of relational database 336 and non-relational database 338.

As another step or stage, conversational assistant agents 354 may include one or more AI agents configured to autonomously generate one or more queries using RAG-assisted LLM and execute the one or more queries against the identified data domains of relational database 336 and non-relational database 338. At least one AI agent of conversational assistant agents 354 may provide, to a first one of GAI models 380, the natural language query to obtain one or more first queries to the first data domain of relational database 332. Another AI agent of conversational assistant agents 354 may provide, to a second one of GAI models 380, the natural language query to obtain one or more second queries to the second data domain of non-relational database 332. In some examples, the first and second GAI models 380 may be RAG-assisted LLMs. For example, a RAG tool may guide the first and second GAI models 380 by providing data assigned to the one or more topics of the natural language query. As noted above, each topic may be assigned one or more data structures and corresponding schemas of relational database 336, one or more data structures and corresponding schemas of non-relational database 338, and topic-specific context examples.

Other AI agents may then query the first data domain of relational database 332 using the one or more first queries to obtain data from the first data domain, and query the second data domain of non-relational database 332 using the one or more second queries to obtain data from the second data domain.

As a further step or stage, conversational assistant agents 354 may include at least one AI agent configured to autonomously generate instructions to join the data obtained from the first data domain of relational database 336 and the second data domain of non-relational database 338 into a single data structure. The AI agent may provide, to one of GAI models 380, the first schema of the first data domain and the second schema of the second data domain to obtain high-level programming language code, e.g., Python code, to join the data obtained from the first data domain and the data obtained from the second data domain. The AI agent may construct the single data structure in which to hold the joined data obtained from the first data domain and the second data domain. In some examples, the instructions may comprise a variety of data combination techniques, including one or more unions, a single join, multiple joins, and/or a join of joins. In SQL databases, a join combines data horizontally (i.e., merging columns from related data sets), while a union combines data vertically (i.e., stacking rows from similar data sets). NoSQL databases may provide operations that mimic or are similar to joins and unions, but may not include native join or union operations.

The techniques described herein to dynamically join data from across relational database 336 and non-relational database 338 may be especially useful for network analytics. For example, the natural language query may be associated with real-time or short term network data 348 (e.g., last 7 days) of network and network device operation stored in non-relational database 338 but in the context of historical or long term network data 346 (e.g., last 1 year) indicative of seasonality of the network or network device operation stored in relational database 336. In the illustrated example, short term network data 348 and long term network data 346 are stored in different types of databases with different time frames and different formats.

In order to join the data obtained from the different types of databases 336, 338, the AI agent of conversational assistant agents 354 learns the context of the data included in each of the first data domain and the second data domain to determine how to join and what to join. In some examples, the AI agent may use first schema of the first data domain of relational database 336 and the second schema of the second data domain of non-relational database 338, which define the structure, content, and/or time frame of the data stored in the data structures included in the respective data domains. For example, the AI agent may normalize and align data fields in the data structures within the first and second data domains to identify matching data fields between the data domains. Similarly, the AI agent may normalize and align time frames of the data structures within the first and second data domains. The AI agent may then combine and/or correlate the data obtained from the first data domain of relational database 336 and the data obtained from the second data domain of non-relational database 338 into the single data structure.

As a further step or stage, conversational assistant agents 354 may include at least one AI agent configured to autonomously generate a visualization based on the joined data held in the single data structure and output the visualization as a response to the natural language query. The AI agent may provide, to one of GAI models 380, the natural language query and the joined data to obtain a structure for the visualization, e.g., a circle graph, pie chart, bar graph, line graph, table, etc., that may be best suited to present the joined data. The AI agent may then generate the visualization according to the determined structure based on the joined data. The visualization may be output via UI 310 for display to a network administrator for an enterprise network of a customer organization, e.g., via an admin device.

Although the techniques of the present disclosure are described in this example as performed by NMS 300, techniques described herein may be performed by any other computing device(s), system(s), and/or server(s), and that the disclosure is not limited in this respect. For example, one or more computing device(s) configured to execute the functionality of the techniques of this disclosure may reside in a dedicated server or be included in any other server in addition to or other than NMS 300, or may be distributed throughout a network, and may or may not form a part of NMS 300.

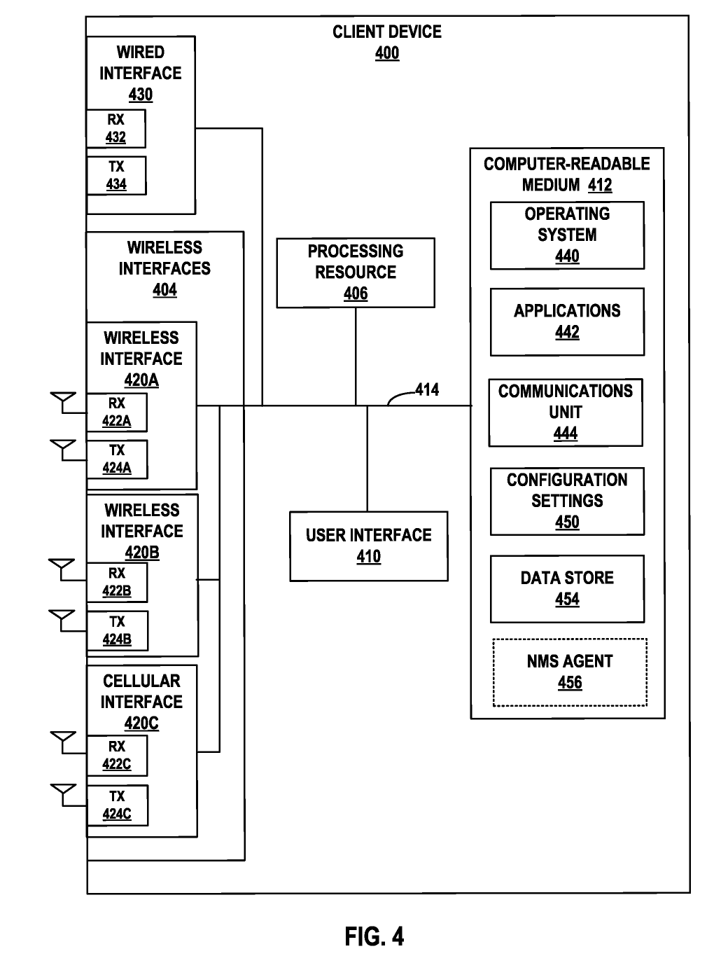

FIG. 4 shows an example client device 400, in accordance with one or more techniques of this disclosure. Example client device 400 shown in FIG. 4 may be used to implement any of client devices 148 as shown and described herein with respect to FIG. 1A. Client device 400 may include any type of wireless client device, and the disclosure is not limited in this respect. For example, client device 400 may include a mobile device such as a smart phone, tablet or laptop computer, a personal digital assistant (PDA), a wireless terminal, a smart watch, a smart ring, or any other type of mobile or wearable device. In some examples, client device 400 may also include a wired client-side device, e.g., an IoT device such as a printer, a security sensor or device, an environmental sensor, or any other device connected to the wired network and configured to communicate over one or more wireless networks.

Client device 400 includes a wired interface 430, wireless interfaces 420A-420C, processing resource 406, computer-readable medium 412, and a user interface 410. The various elements are coupled together via a bus 414 over which the various elements may exchange data and information. Wired interface 430 represents a physical network interface and includes a receiver 432 and a transmitter 434. Wired interface 430 may be used, if desired, to couple, either directly or indirectly, client device 400 to a wired network device, such as a switch, within the wired network via a cable, such as an Ethernet cable.

First, second and third wireless interfaces 420A, 420B, and 420C include receivers 422A, 422B, and 422C, respectively, each including a receive antenna via which client device 400 may receive wireless signals from wireless communications devices, such as APs, other client devices, or other devices configured for wireless communication. First, second, and third wireless interfaces 420A, 420B, and 420C further include transmitters 424A, 424B, and 424C, respectively, each including transmit antennas via which client device 400 may transmit wireless signals to wireless communications devices, such as APs, other client devices, and/or other devices configured for wireless communication. In some examples, first wireless interface 420A may include a Wi-Fi 802.11 interface (e.g., 2.4 GHz and/or 5 GHz) and second wireless interface 420B may include a Bluetooth interface and/or a Bluetooth Low Energy interface. Third wireless interface 420C may include, for example, a cellular interface through which client device 400 may connect to a cellular network.

Processing resource 406 executes software instructions, such as those used to define a software or computer program, stored to a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause processing resource 406 to perform the techniques described herein.

Computer-readable medium 412 includes one or more devices configured to store programming units and/or data associated with operation of client device 400. For example, computer-readable medium 412 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause processing resource 406 to perform the techniques described herein.

In this example, computer-readable medium 412 includes an operating system 440, applications 442, a communications unit 444, configuration settings 450, and data store 454. Communications unit 444 includes program code that, when executed by processing resource 406, enables client device 400 to communicate using any of wired interface(s) 430, wireless interfaces 420A-420B and/or cellular interface 450C. Configuration settings 450 include any device settings for client device 400 settings for each of wireless interface(s) 420A-420B and/or cellular interface 420C.

Data store 454 may include, for example, a status/error log including a list of events specific to client device 400. The events may include a log of both normal events and error events according to a logging level based on instructions from a network management system. Data store 454 may store any data used and/or generated by client device 400, such as data used to calculate one or more SLE metrics or identify relevant behavior, that is collected by client device 400 and either transmitted directly to the network management system or transmitted to any APs in a wireless network for further transmission to the network management system.

As described herein, client device 400 may measure and report network data from data store 454 to a network management system. The network data may comprise event data, telemetry data, and/or other SLE-related data. The network data may include various parameters indicative of the performance and/or status of the wireless network. The network management system may determine one or more SLE metrics and store the SLE metrics as network data based on the SLE-related data received from the client devices in the wireless network.

Optionally, client device 400 may include an NMS agent 456. NMS agent 456 is a software agent of the network management system that is installed on client device 400. In some examples, NMS agent 456 can be implemented as a software application running on client device 400. NMS agent 456 collects information including detailed client-device properties from client device 400, including insight into client device 400 roaming behaviors. The information provides insight into client roaming algorithms, because roaming is a client device decision. In some examples, NMS agent 456 may display the client-device properties on client device 400. NMS agent 456 sends the client device properties to the network management system, via an AP device to which client device 400 is connected. NMS agent 456 can be integrated into a custom application or as part of location application. NMS agent 456 may be configured to recognize device connection types (e.g., cellular or Wi-Fi), along with the corresponding signal strength. For example, NMS agent 456 recognizes access point connections and their corresponding signal strengths. NMS agent 456 can store information specifying the APs recognized by client device 400 as well as their corresponding signal strengths. NMS agent 456 or another element of client device 400 also collects information about the APs with which the client device 400 is connected, which also indicates the APs with which the client device 400 did not connect. NMS agent 456 of client device 400 sends this information to the network management system via its connected AP. In this manner, client device 400 sends information about not only the AP with which client device 400 connected and their signal strengths, but also information about other APs which client device 400 recognized and did not connect. The AP in turn forwards this information to the network management system, including the information about other APs the client device 400 recognized besides itself. This additional level of granularity enables the network management system, and ultimately network administrators, to better determine the Wi-Fi experience directly from the client device’s perspective.

In some examples, NMS agent 456 further enriches the client device data leveraged in service levels. For example, NMS agent 456 may go beyond basic fingerprinting to provide supplemental details into properties such as device type, manufacturer, and different versions of operating systems. In the detailed client properties, the network management system can display the radio hardware and firmware information of client device 400 received from NMS client agent 456. The more details the NMS agent 456 can draw out, the better the VNA/AI engine gets at advanced device classification. The VNA/AI engine of the network management system continually learns and becomes more accurate in its ability to distinguish between device-specific issues or broad device issues, such as specifically identifying that a particular OS version is affecting certain clients.

In some examples, NMS agent 456 may cause user interface 410 to display a prompt that prompts an end user of client device 400 to enable location permissions before NMS agent 456 is able to report the device’s location, client information, and network connection data to the NMS. NMS agent 456 will then start reporting connection data to the NMS along with location data. In this manner, the end user of the client device can control whether the NMS agent 456 is enabled to report client device information to the NMS.

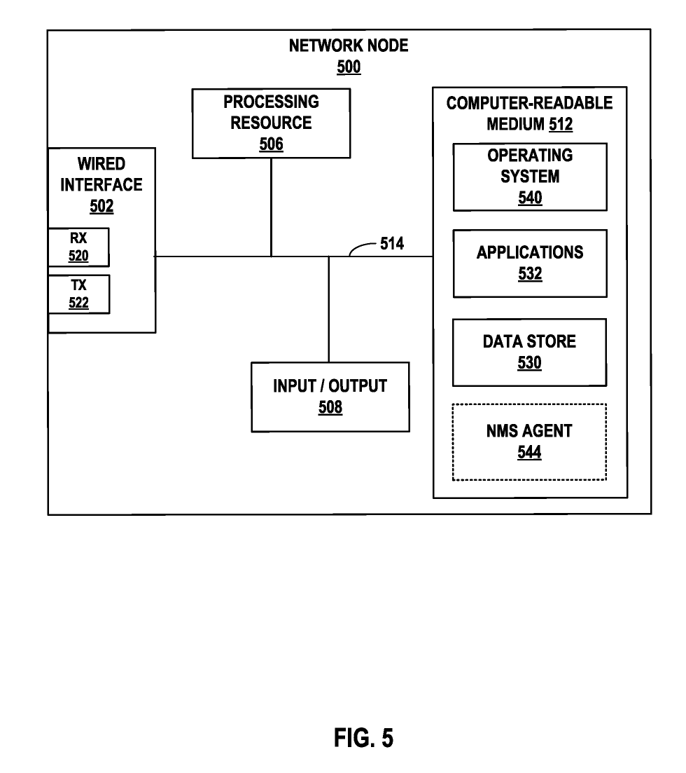

FIG. 5 is a block diagram illustrating an example network node 500, in accordance with one or more techniques of this disclosure. In one or more examples, the network node 500 implements a device or a server attached to the network 104 of FIG. 1A, e.g., switches 146, AAA server 110, DHCP server 116, DNS server 122, web servers 128, etc., or another network device supporting one or more of wireless network 106, wired LAN 175, or SD-WAN 177, or data center 179 of FIG. 1B, e.g., gateway routers 187.

In this example, network node 500 includes a wired interface 502, e.g., an Ethernet interface, processing resource 506, input/output 508, e.g., display, buttons, keyboard, keypad, touch screen, mouse, etc., and a computer-readable medium 512 coupled together via a bus 514 over which the various elements may interchange data and information. Wired interface 502 couples the network node 500 to a network, such as an enterprise network. Though only one interface is shown by way of example, network nodes may, and usually do, have multiple communication interfaces and/or multiple communication interface ports. Wired interface 502 includes a receiver 520 and a transmitter 522.

Computer-readable medium 512 stores executable software applications 532, operating system 540 and data store 530. Data store 530 may include a system log and/or an error log that stores event data, including behavior data, for network node 500. Data store 530 may store any data used and/or generated by network node 500. In examples where network node 500 comprises a “third-party” network device, the same entity does not own or have access to both the APs or wired client-side devices and network node 500. As such, in the example where network node 500 is a third-party network device, a network management system does not receive, collect, or otherwise have access to the network data in data store 530 of network node 500.

In examples where network node 500 comprises a server, network node 500 may receive data and information, e.g., including operation related information, e.g., registration request, AAA services, DHCP requests, Simple Notification Service (SNS) lookups, and Web page requests via receiver 520, and send data and information, e.g., including configuration information, authentication information, web page data, etc. via transmitter 522.

In examples where network node 500 comprises a wired network device, network node 500 may be connected via wired interface 502 to one or more APs or other wired client-side devices, e.g., IoT devices. For example, network node 500 may include multiple wired interfaces 502 and/or wired interface 502 may include multiple physical ports to connect to multiple APs or the other wired-client-side devices within a site via respective Ethernet cables. In some examples, each of the APs or other wired client-side devices connected to network node 500 may access the wired network via wired interface 502 of network node 500. In some examples, one or more of the APs or other wired client-side devices connected to network node 500 may each draw power from network node 500 via the respective Ethernet cable and a Power over Ethernet (PoE) port of wired interface 502.

In examples where network node 500 comprises a session-based router that employs a stateful, session-based routing scheme, network node 500 may be configured to independently perform path selection and traffic engineering. The use of session-based routing may enable network node 500 to eschew the use of a centralized controller, such as an SDN controller, to perform path selection and traffic engineering, and eschew the use of tunnels. In some examples, network node 500 may implement session-based routing as Secure Vector Routing (SVR). In the case where network node 500 comprises a session-based router operating as a network gateway for a site of an enterprise network, network node 500 may establish multiple peer paths over an underlying physical WAN with one or more other session-based routers operating as network gateways for other sites of the enterprise network. Network node 500, operating as a session-based router, may collect data at a peer path level, and report the peer path data to a network management system.

In examples where network node 500 comprises a packet-based router, network node 500 may employ a packet- or flow-based routing scheme to forward packets according to defined network paths, e.g., established by a centralized controller that performs path selection and traffic engineering. In the case where network node 500 comprises a packet-based router operating as a network gateway for a site of an enterprise network, network node 500 may establish multiple tunnels over an underlying physical WAN with one or more other packet-based routers operating as network gateways for other sites of the enterprise network. Network node 500, operating as a packet-based router, may collect data at a tunnel level, and the tunnel data may be retrieved by a network management system via an API or an open configuration protocol or the tunnel data may be reported to the network management system by NMS agent 544 or another unit running on network node 500.

The data collected in data store 530 and reported by network node 500 may include periodically reported statistical data and asynchronously reported event data. Network node 500 is configured to collect logical path statistics via bidirectional forwarding detection (BFD) probing and data extracted from messages and/or counters at the logical path (e.g., peer path or tunnel) level. In some examples, network node 500 is configured to collect statistics and/or sample other data according to a first periodic interval, e.g., every 3 seconds, every 5 seconds, etc. Network node 500 may store the collected and sampled data as path data in data store 530.

In some examples, network node 500 optionally includes an NMS agent 544. NMS agent 544 may periodically create a package of the statistical data according to a second periodic interval, e.g., every 3 minutes. In some examples, the package of statistical data may also include details about clients connected to network node 500 and the associated client sessions. NMS agent 544 may then report the package of statistical data to the network management system in the cloud. In other examples, the network management system may request, retrieve, or otherwise receive the package of statistical data from network node 500 via an API, an open configuration protocol, or another of communication protocols. The package of statistical data created by NMS agent 544 or another unit of network node 500 may include a header identifying network node 500 and the statistics and data samples for each of the logical paths from network node 500. In still other examples, NMS agent 544 reports event data to the network management system in the cloud asynchronously, i.e., in response to the occurrence of certain events at network node 500 as the events happen.

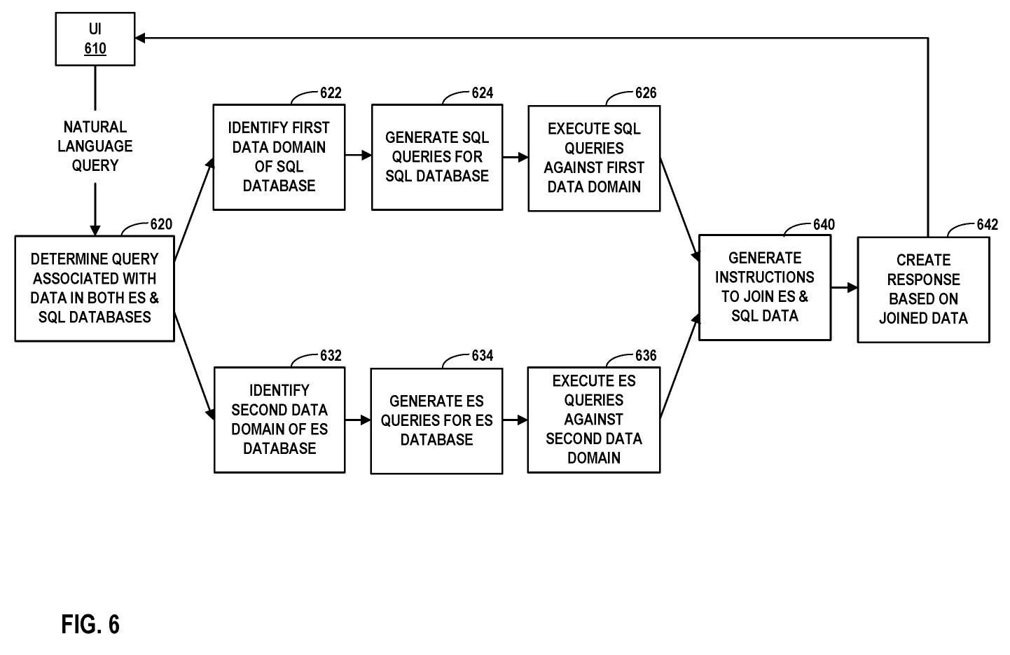

FIG. 6 is a flowchart illustrating an example operation of joining data from data domains of relational and non-relational databases for use by a generative artificial intelligence (GAI) model to accurately respond to a natural language query, in accordance with one or more techniques of this disclosure. The example operation of FIG. 6 may be performed by NMS 130 of FIG. 1A. In other examples, the operation of FIG. 6 may be performed by NMS 300 of FIG. 3.

Conversational assistant agents of a network management system (NMS) receive, via a user interface 610, a natural language query. The conversational assistant agents may use a GAI model to determine that at least a first portion of the natural language query is associated with data stored in a relational database, e.g., a SQL database storing long term data, and at least a second portion of the natural language query is associated with data stored in a non-relational database, e.g., an ES database storing real-time or short term data (620). In other examples, the non-relational database may comprise another type of NoSQL database, such as Cassandra.

The conversational assistant agents then identify data domains, generate queries, and execute queries for each of the SQL database and the ES database. With respect to the SQL database, the conversational assistant agents determine or select a first data domain of the SQL database as storing data relevant to the natural language query (622). As one example, the conversational assistant agents may classify the natural language query into one or more topics of a plurality of topics (e.g., between eight and twelve topics) and determine the first data domain of the SQL database as including data relevant to the one or more topics of the natural language query. As another example, the conversational assistant agents may provide the natural language query to a GAI model to obtain a selection of the first data domain comprising one or more data structures of a plurality of data structures within the SQL database. The first data domain of the SQL database may comprise one or more tables, e.g., between five and fifteen tables, of a plurality of tables, e.g., hundreds of tables, within the SQL database.

The conversational assistant agents then provide the natural language query to a GAI model to obtain one or more SQL queries to the first data domain of the SQL database (624). In some examples, the conversational assistant agents may use a RAG tool to guide the GAI model based on data assigned to the one or more topics to which the natural language query was assigned. In some examples, each topic of the plurality of topics is assigned one or more data structures and corresponding schemas of the SQL database, one or more data structures and corresponding schemas of the ES database, and/or one or more example queries and corresponding responses. The RAG tool may apply some or all of the data assigned to the one or more topics to which the natural language query was assigned to the GAI model to improve efficiency and accuracy of the GAI model in obtaining data from the first data domain of the SQL database that is highly relevant to the natural language query.

In some examples, the conversational assistant agents may perform one or more techniques to verify the SQL queries obtained from the GAI model. As one example, the conversational assistant agents may identify “nouns” included in the natural language query that are meaningful in the context of network management, e.g., names of network devices, networks, organizations, and the like. The conversational assistant agents may perform spell check or otherwise verify the correct nouns from the natural language query are included in the resulting SQL queries, e.g., using standard techniques such as Levenshtein to measure the difference between two strings. As another example, the conversational assistant agents may compare the natural language query from which a SQL query was generated and an original SQL query to verify that they are sufficiently matched.

The conversational assistant agents execute the SQL queries against the first data domain of the SQL database based on the natural language query (626). The conversational assistant agents obtain data from the first data domain of the SQL database based on the one or more SQL queries. In some scenarios, the conversational assistant agents may perform one or more techniques to identify and/or correct errors in the SQL queries using a GAI model. For example, if a SQL query is flawed such that it does not execute, the conversation assistant agents may use a GAI model to correct errors in the SQL query based on an error message and the data domain associated with the SQL query. In this way, the conversational assistant agents may retry the failed SQL query generation by using the generated error in the query to self-correct using the GAI model.

With respect to the ES database, the conversational assistant agents determine or select a second data domain of the ES database as storing data relevant to the natural language query (632). As one example, the conversational assistant agents may classify the natural language query into one or more topics of a plurality of topics (e.g., between eight and twelve topics) and determine the second data domain of the ES database as including data relevant to the one or more topics of the natural language query. As another example, the conversational assistant agents may provide the natural language query to a GAI model to obtain a selection of the second data domain comprising one or more data structures of a plurality of data structures within the ES database. The second data domain of the ES database may comprise one or more indices, e.g., one or two indices, of a plurality of indices within the ES database.

The conversational assistant agents then provide the natural language query to a GAI model to obtain one or more ES queries to the second data domain of the ES database (634). In some examples, the conversational assistant agents may use a RAG tool to guide the GAI model based on data assigned to the one or more topics to which the natural language query was assigned. The RAG tool may apply some or all of the data assigned to the one or more topics to which the natural language query was assigned to the GAI model to improve efficiency and accuracy of the GAI model in obtaining data from the second data domain of the ES database that is highly relevant to the natural language query. In some examples, the conversational assistant agents may perform one or more techniques to verify the ES queries obtained from the GAI model similar to those described above with respect to the SQL queries.

The conversational assistant agents execute the ES queries against the second data domain of the ES database based on the natural language query (636). The conversational assistant agents obtain data from the second data domain of the ES database based on the one or more ES queries. In some scenarios, the conversational assistant agents may perform one or more techniques to identify and/or correct errors in the ES queries using a GAI model similar to those described above with respect to the SQL queries.

The conversational assistant agents dynamically generate join instructions based on a first schema of the first data domain of the SQL database and a second schema of the second data domain of the ES database to join data obtained from the first data domain and data obtained from the second data domain into a single data structure (640). The conversational assistant agents may provide the first schema of the first data domain and the second schema of the second data domain to a GAI model to obtain high-level programming language code, e.g., Python code, to join the data obtained from the first data domain of the SQL database and the data obtained from the second data domain of the ES database. The conversational assistant agents may normalize or align content of the first data domain of the SQL database with content of the second data domain of the ES database and/or may normalize or align a time frame associated with the first data domain of the SQL database with a time frame of the second data domain of the ES database. In some examples, the conversational assistant agents may construct the single data structure in which to hold the joined data obtained from the first data domain and the second data domain.

Although described above as a single join operation of data obtained from two data domains of different database types, in other examples the dynamically generated join instructions may comprise multiple join operations to combine data obtained from multiple data domains data of different database types. For example, the join instructions may join data obtained from five or six different data domains of the SQL database and data obtained from one or two different data domains of the ES database into the single data structure. In still other examples, the dynamically generated join instructions may comprise a “join of joins” to combine data obtained obtained from multiple data domains of different database types. For example, the join instructions may first join data obtained from two or more data domains or tables of the SQL database into a first virtual data structure. The join instructions may then join data obtained from two or more data domains or indices of the ES database into a second virtual data structure. The join instructions may finally join the data in the first virtual data structure and the second virtual data structure into the single data structure. In addition, although primarily described herein as including “join” operations that combine data horizontally (i.e., merging columns from related data sets), the join instructions may also include “union” operations that combine data vertically (i.e., stacking rows from similar data sets).

The conversational assistant agents create a response to the natural language query based on the joined data (642). The conversational assistant agents may generate a visualization based on the joined data held in the single data structure and output the visualization for display via UI 610. In some examples, the conversational assistant agents may provide the natural language query and the joined data to a GAI model to determine a structure for the visualization, e.g., a circle graph, pie chart, bar graph, line graph, table, etc., that may be best suited to present the joined data. The conversational assistant agents may then generate the visualization according to the determined structure based on the joined data.

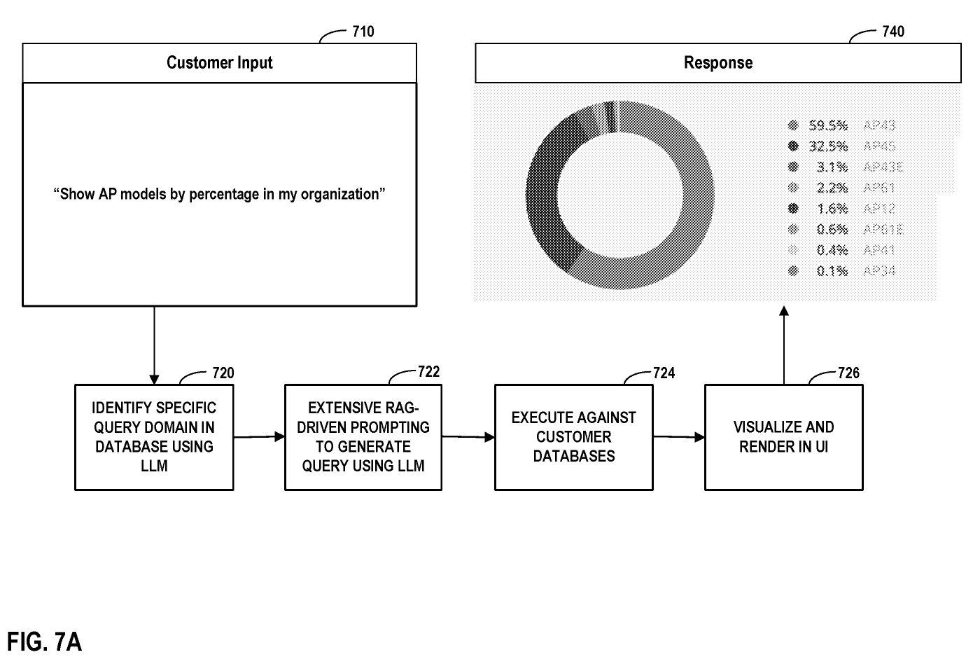

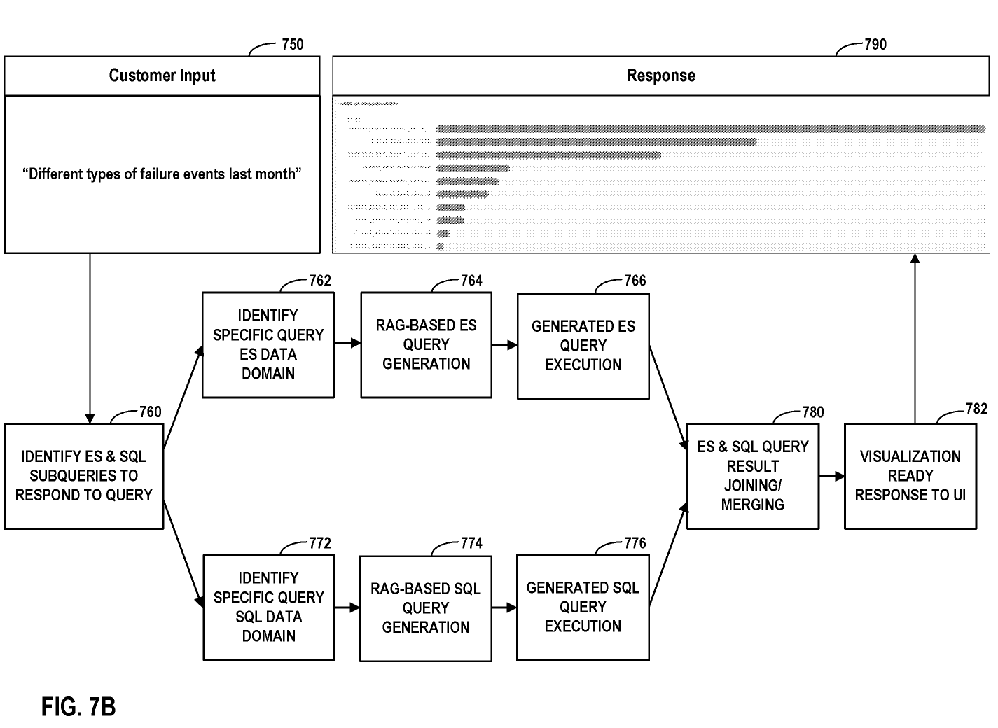

FIGS. 7A-7B are conceptual diagrams of example customer input to and responses created by a conversational assistant having an agentic AI architecture, in accordance with one or more techniques of this disclosure. The operational steps illustrated by FIGS. 7A-7B may be performed by NMS 300 of FIG. 3. In other examples, the operational steps may be performed by NMS 130 of FIGS. 1A-1B.

In the example of FIG. 7A, the customer input 710 may be a natural language query of “show AP models by percentage in my organization.” Conversational assistant agents of a network management system (NMS) may provide the natural language query to an LLM, e.g., a GAI model, to identify data domains of a relational database and a non-relational database as storing data relevant to the natural language query based on schemas corresponding to data structures within the databases (720). For example, the conversational assistant agents may identify certain tables, trees, lists or indices of a database that store identification data of APs configured for each of a plurality of sites, and may identify certain other tables, trees, lists or indices of a database that store a mapping of sites to an enterprise network of the customer’s organization. In this example, a majority of the data relevant to the natural language query may be stored in the relational database as long term network data, but data of more recently added or configured APs may be stored in short term network data of the non-relational database.

The conversational assistant agents may then provide the natural language query to a RAG-assisted LLM, e.g., another GAI model, to obtain one or more queries to a data domain of each of the relational database and the non-relational database (722). The conversational assistant agents may then execute the one or more queries against each of the relational database and the non-relational database (724). The conversational assistant agents may provide the data obtained from each of the relational database and the non-relational database to another GAI model to dynamically generate join instructions based on the schemas of the data domains of the relational database and the non-relational database to cause the NMS to join data obtained from the data domain of the relation database and data obtained from the data domain of the non-relational database into a single data structure.

The conversational assistant agents then create a response 740 to the natural language query based on the joined data (726). In some examples, the conversational assistant agents may provide the natural language query and the joined data to an LLM, e.g., another GAI model, to obtain a structure for a visualization that provides an ideal or optimized way of presenting the joined data. For example, the LLM may determine that a circle graph or pie chart is the best way to present percentage data for the number of different AP models identified in the customer’s organization. In the illustrated example of FIG. 7A, the response 740 comprises a visualization of a circle graph indicating the percentages of eight different types of AP models in the customer’s organization that is output for display to a network administrator for the enterprise network of the customer’s organization, e.g., via an admin device.

In the example of FIG. 7B, the customer input 750 may be a natural language query of “Different types of failure events last month.” The conversation assistant agents of the NMS may determine that at least a first portion of the natural language query is associated with data stored in the relational database, e.g., a SQL database storing long term network data that is more than 7 days old, and at least a second portion of the natural language query is associated with data stored in the non-relational database, e.g., an ES database storing short term network data that includes a most recent week or 7-days of data (760). The conversational assistant agents then identify data domains, generate queries, and execute queries for each of the SQL database (762, 764, 766) and the ES database (772, 774, 776).

The conversational assistant agents may provide the natural language query to an LLM, e.g., a GAI model, to identify a data domain of the SQL database as storing data relevant to the natural language query based on schemas corresponding to one or mere tables of the SQL database (762). For example, the conversational assistant agents may identify certain tables that each store failure events by event type, network device, and/or site, and may identify certain other tables that store a mapping of network devices and/or sites to an enterprise network of the customer’s organization. The conversational assistant agents may then provide the natural language query to a RAG-assisted LLM, e.g., another GAI model, to obtain one or more SQL queries to a data domain of the SQL database (764). The conversational assistant agents may then execute the one or more SQL queries against the SQL database (766).

Similarly, the conversational assistant agents may provide the natural language query to an LLM, e.g., another GAI model, to identify a data domain of the ES database as storing data relevant to the natural language query based on schemas corresponding to one or mere indices of the ES database (772). For example, the conversational assistant agents may identify certain indices that each store failure events by event type, network device, and/or site, and may identify certain other indices that store a mapping of network devices and/or sites to the enterprise network of the customer’s organization. The conversational assistant agents may then provide the natural language query to a RAG-assisted LLM, e.g., another GAI model, to obtain one or more ES queries to a data domain of the ES database (774). The conversational assistant agents may then execute the one or more ES queries against the ES database (776).

The conversational assistant agents may provide the data obtained from each of the SQL database and the ES database to another GAI model to dynamically generate join instructions based on the schemas of the data domains of the SQL database and the ES database to cause the NMS to join data obtained from the data domain of the SQL database and data obtained from the data domain of the ES database into a single data structure (780). For example, the conversational assistant agents may normalize or align the data fields in the tables of the data domain of the SQL database with the data fields in the indices of the data domain of the ES database to combine and/or correlate the error types stored in each database. The conversational assistant agents may also normalize or align the time frame for the data in the tables of the data domain of the SQL database, e.g., stored hourly or daily after 7-days, with the time frame for the data in the indices of the data domain of the ES database, e.g., stored individually or by the minute for up to 7-days.

The conversational assistant agents then create a response 790 to the natural language query based on the joined data (782). In some examples, the conversational assistant agents may provide the natural language query and the joined data to an LLM, e.g., another GAI model, to obtain a structure for a visualization that provides an ideal or optimized way of presenting the joined data. For example, the LLM may determine that a bar graph is the best way to present quantity data for the number of different types of failure events identified over the last month in the customer’s organization. In the illustrated example of FIG. 7B, the response 790 comprises a visualization of a bar graph indicating a quantity of ten different types of failure events in the customer’s organization that is output for display to a network administrator for the enterprise network of the customer’s organization, e.g., via an admin device.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processing resources, rather than sequentially. Further, certain operations, acts, steps, or events may be performed automatically, even if not specifically identified as being performed automatically. Also, certain operations, acts, steps, or events described as being performed automatically may be alternatively not performed automatically, but rather, such operations, acts, steps, or events may be, in some examples, performed in response to input or another event.

Although various Figures are referenced herein in connection with the description of one or more specific examples, such examples are merely illustrative, and each Figure can be used to provide support for other examples not specifically described herein. Accordingly, the one or more examples described herein with reference to a specific Figure should not be construed to narrow the scope or spirit of the subject matter illustrated in that Figure or any other illustration.

In the preceding description, references may be occasionally made to “some examples.” In this disclosure, a reference to “some examples” is intended to mean a subset of all of the possible examples supported by this disclosure. Also, different references to “some examples” are not always a reference to the same subset of examples.

For ease of illustration, only a limited number of systems are shown within the illustrations referenced herein. However, techniques in accordance with one or more aspects of the present disclosure may be performed with many more of such systems, components, devices, applications, units, and/or other items, and collective references to such systems, components, devices, applications, units, and/or other items may represent any number of such systems, components, devices, applications, units, and/or other items.

The illustrations included herein depict at least one example implementation of an aspect of this disclosure. The scope of this disclosure is not, however, limited to such implementations. Accordingly, other examples or alternative implementations of systems, methods or techniques described herein, beyond those illustrated, may be used in other instances. Such implementations may include a subset of the devices and/or components included in the illustrations, and/or may include additional devices and/or components not specifically illustrated.

The description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, known structures and components are shown in block diagram form in the referenced illustrations in order to avoid obscuring such concepts.

Accordingly, although one or more implementations of various systems, devices, and/or components may be described with reference to specific illustrations, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated herein may alternatively be implemented as part of another device or component not shown in such illustrations. In this and other ways, some of the functions described herein may be performed via distributed processing by two or more devices or components.

Further, certain operations, techniques, features, and/or functions may be described herein as being performed by specific components, devices, applications and/or units. In other examples, such operations, techniques, features, and/or functions may be performed by different components, devices, applications, or units. Accordingly, some operations, techniques, features, and/or functions that may be described herein as being attributed to one or more components, devices, applications and/or units may, in other examples, be attributed to other components, devices, applications and/or units, even if not specifically described herein in such a manner. Any references herein to “real time” or equivalent phrases are intended to encompass near-real time or seemingly near-real time, such as from the perspective of a reasonable human observer.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media; or communication media including any medium that facilitates transfer of a computer program from one place to another (e.g., pursuant to a communication protocol). In this manner, computer-readable media generally may correspond to (1) tangible computer-readable storage media, which is non-transitory computer-readable storage media or (2) a communication medium such as a signal or carrier wave. Data storage media may be any available media that can be accessed by one or more computers or one or more processing resources to retrieve instructions, code and/or data structures for implementation of the techniques described in this disclosure. A computer program product may include a computer-readable medium.

By way of example, and not limitation, such computer-readable storage media can include random-access memory (RAM), read-only memory (ROM), non-volatile random-access memory (NVRAM), electrically erasable programmable read-only memory (EEPROM), Flash memory, optical data storage media, magnetic disk storage, or other magnetic storage devices, Solid-State Drive (SSD) storage, or any other medium that can be used to store desired program code in the form of instructions or data structures and that can be accessed by a computer. Also, any connection may properly be referred to as a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium.

Instructions may be executed by one or more processing resources, such as one or more Central Processing Units (CPUs), Graphics Processing Units (GPUs), Digital Signal Processors (DSPs), microprocessors, controllers, Application-Specific Integrated Circuits (ASICs), Field-Programmable Gate Arrays (FPGAs), quantum processors, or other equivalent integrated or discrete logic circuitry. One or more processing resources may be, may be part of, and/or may include processing circuitry that performs operations in accordance with one or more aspects of the present disclosure. The terms “processing resource,” “processor,” or “processing circuitry” as used herein may each refer to any of the foregoing structure or any other structure suitable for implementation of the techniques described. In addition, in some examples, the functionality described may be provided within dedicated hardware and/or software applications and/or units. One or more processing resources of a computing system may implement functionality and/or execute instructions associated with the computing system or associated with one or more applications and/or units illustrated herein and/or described herein. Also, the techniques could be fully implemented in one or more circuits or logic elements.

Where a phrase similar to “at least one of A, B, and C” is used in the claims, it is intended that the phrase be interpreted to mean that A alone may be present; B alone may be present; C alone may be present; or that any combination of the elements A, B, and C may be present, for example, A and B, A and C, B and C, or A and B and C.

Where a phrase similar to “one or more processing resources configured to X, Y, and Z” is used in the claims, it is intended that the phrase be interpreted to mean at least: that a first processing resource alone may perform functions X, Y, and Z; that two or more processing resources (e.g., processors A and B) may collectively perform functions X, Y, and Z; that a first processing resource may perform functions X and Y and a second processing resource may perform function Z; or that a first processing resource may perform function X, a second processing resource may perform function Y, and a third processing resource may perform function Z. Furthermore, the phrase “instructions executable by the one or more processing resources to cause the computing system to” or similar phrase is intended to encompass functions performed by the computing system and resulting from the execution of the instructions by any combination of the one or more the processing resources.

The techniques of this disclosure may be implemented in a wide variety of devices or apparatuses, including, to the extent appropriate, a mobile or non-mobile computing device, a wearable or non-wearable computing device, an integrated circuit (IC) or a set of ICs (e.g., a chip set). Various components, applications, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processing resources as described above, in conjunction with suitable software and/or firmware.

What is claimed is:

1. A computing system comprising:
one or more processing resources; and
one or more non-transitory computer-readable storage media comprising instructions executable by the one or more processing resources to cause the computing system to:
receive, via a user interface, a natural language query;
query a first data domain of a relational database based on the natural language query;
query a second data domain of a non-relational database based on the natural language query;
dynamically generate join instructions based on a first schema of the first data domain of the relational database and a second schema of the second data domain of the non-relational database, wherein the join instructions cause the computing system to join data obtained from the first data domain and data obtained from the second data domain into a single data structure; and
create a response to the natural language query based on the joined data.

2. The computing system of claim 1, wherein the relational database comprises a Structured Query Language (SQL) database storing long term data, and wherein the non-relational database comprises a Not Only SQL (NoSQL) database storing real-time data or short term data.

3. The computing system of claim 1, wherein the instructions cause the computing system to determine at least a first portion of the natural language query associated with data stored in the relational database and at least a second portion of the natural language query associated with data stored in the non-relational database.

4. The computing system of claim 1, wherein the instructions cause the computing system to:
classify the natural language query into one or more topics of a plurality of topics;
determine the first data domain of the relational database as including data relevant to the one or more topics of the natural language query; and
determine the second data domain of the non-relational database as including data relevant to the one or more topics of the natural language query.

5. The computing system of claim 1, wherein the instructions cause the computing system to:
provide, to a first generative artificial intelligence (GAI) model, the natural language query to obtain a selection of the first data domain comprising one or more data structures of a plurality of data structures within the relational database; and
provide, to a second GAI model, the natural language query to obtain a selection of the second data domain comprising one or more data structures of a plurality of data structures within the non-relational database.

6. The computing system of claim 1, wherein the instructions cause the computing system to:
provide, to a first generative artificial intelligence (GAI) model, the natural language query to obtain one or more first queries to the first data domain of the relational database, and wherein to query the first data domain, the instructions cause the computing system to query the first data domain of the relational database using the one or more first queries; and
provide, to a second GAI model, the natural language query to obtain one or more second queries to the second data domain of the relational database, and wherein to query the second data domain, the instructions cause the computing system to query the second data domain of the non-relational database using the one or more second queries.

7. The computing system of claim 6, wherein the instructions cause the computing system to classify the natural language query into one or more topics of a plurality of topics, and wherein a retrieval-augmented generation (RAG) guides one or more of the first GAI or the second GAI based on data assigned to the one or more topics.

8. The computing system of claim 7, wherein each topic of the plurality of topics is assigned one or more data structures and corresponding schemas of the relational database, one or more data structures and corresponding schemas of the non-relational database, and one or more example queries and corresponding responses.

9. The computing system of claim 6, wherein the instructions cause the computing system to obtain the data from the first data domain based on the one or more first queries and obtain the data from the second data domain based on the one or more second queries.

10. The computing system of claim 1, wherein to dynamically generate the join instructions, the instructions cause the computing system to provide, to a generative artificial intelligence model, the first schema of the first data domain and the second schema of the second data domain to obtain high-level programming language code to join the data obtained from the first data domain and the data obtained from the second data domain.

11. The computing system of claim 1, wherein to dynamically generate the join instructions, the instructions cause the computing system to one or more of:
normalize or align content of the first data domain of the relational database with content of the second data domain of the non-relational database; or
normalize or align a time frame associated with the first data domain of the relational database with a time frame of the second data domain of the non-relational database.

12. The computing system of claim 1, wherein the join instructions further cause the computing system to construct the single data structure in which to hold the joined data obtained from the first data domain and the second data domain.

13. The computing system of claim 1, wherein to create the response, the instructions cause the computing system to:
generate a visualization based on the joined data held in the single data structure; and
output, for display via the user interface, the visualization.

14. The computing system of claim 13, wherein the generate the visualization, the instructions cause the computing system to:
provide, to a generative artificial intelligence model, the natural language query and the joined data to obtain a structure for the visualization; and
generate the visualization according to the structure based on the joined data.

15. A method comprising:
receiving, by a computing system via a user interface, a natural language query;
determining, by the computing system, that the natural language query is associated with data stored in both a relational database and a non-relational database;
querying, by the computing system, a first data domain of the relational database based on the natural language query;
querying, by the computing system, a second data domain of the non-relational database based on the natural language query;
dynamically generating, by the computing system, join instructions based on a first schema of the first data domain of the relational database and a second schema of the second data domain of the non-relational database, wherein the join instructions cause the computing system to join data obtained from the first data domain and data obtained from the second data domain into a single data structure; and
creating, by the computing system, a response to the natural language query based on the joined data.

16. The method of claim 15, further comprising classifying the natural language query into one or more topics of a plurality of topics, wherein determining that the natural language query is associated with data stored in both the relational database and the non-relational database comprises:
determining the first data domain of the relational database as including data relevant to the one or more topics of the natural language query; and
determining the second data domain of the non-relational database as including data relevant to the one or more topics of the natural language query.

17. The method of claim 15, further comprising:
providing, to a first generative artificial intelligence (GAI) model, the natural language query to obtain a selection of the first data domain comprising one or more data structures of a plurality of data structures within the relational database; and
providing, to a second GAI model, the natural language query to obtain a selection of the second data domain comprising one or more data structures of a plurality of data structures within the non-relational database.

18. The method of claim 15, further comprising:
providing, to a first generative artificial intelligence (GAI) model, the natural language query to obtain one or more first queries to the first data domain of the relational database, wherein querying the first data domain comprises querying the first data domain of the relational database using the one or more first queries; and
providing, to a second GAI model, the natural language query to obtain one or more second queries to the second data domain of the relational database, wherein querying the second data domain comprises querying the second data domain of the non-relational database using the one or more second queries.

19. The method of claim 15, wherein dynamically generating the join instructions comprises providing, to a generative artificial intelligence model, the first schema of the first data domain and the second schema of the second data domain to obtain high-level programming language code to join the data obtained from the first data domain and the data obtained from the second data domain.

20. One or more non-transitory computer-readable storage media comprising instructions executable by one or more processing resources to cause a system to:
receive, via a user interface, a natural language query;
query a first data domain of a relational database based on the natural language query;
query a second data domain of a non-relational database based on the natural language query;
dynamically generate join instructions based on a first schema of the first data domain of the relational database and a second schema of the second data domain of the non-relational database, wherein the join instructions comprise high-level programming language code executable by the one or more processing resources to cause the system to join data obtained from the first data domain and data obtained from the second data domain into a single data structure; and
create a response to the natural language query based on the joined data.
